(19) United States
(12) Patent Application Publication
(10) Pub. No.: US 2007/0143376 A1
(43) Pub. Date: Jun. 21, 2007

(54) Methods, systems, and computer program products for displaying at least one electronic media file on an electronic calendar based on information associated with the electronic calendar

(76) Inventor: Robert McIntosh, Loganville, GA (US)

Correspondence Address: MYERS BIGEL SIBLEY & SAJOVEC, P.A., P.O. BOX 37428, RALEIGH, NC, 27627, US

(21) Appl. No.: 11/303,307

(22) Filed: Dec. 16, 2005

(51) Int. Cl. G06F 17/30

(52) U.S. Cl. 707/205

(57) ABSTRACT

Media files may be displayed on an electronic calendar based on information associated with the electronic calendar. For example, a media file that is associated with a particular day or month may be displayed on the electronic calendar. Media files may also be displayed on the electronic calendar based on other information associated with the electronic calendar, such as a note about a particular activity to take place during a particular time period or a note about meeting a particular person on a certain day. In these cases, a media file related to the activity or a media file related to the person to be met, respectively, may be displayed. The media files may be selected for display on the electronic calendar by tagging the media files so as to organize the media files into categories. The information associated with the electronic calendar can be compared with the tags to select one or more media files that match or relate to the information associated with the electronic calendar. The selected one or more media files can then be displayed on the electronic calendar.

### FIELD OF THE INVENTION

The present invention relates generally to data processing systems and computer program products, and, more particularly, to electronic calendars.

### BACKGROUND OF THE INVENTION

As days and years go by, people generate exponentially increasing volumes of personal information. Such information can include documents, e-mail messages, photos, videos, music collections, Web page content, medical records, etc. This profusion of information can be organized to some degree and presented; however, it may be of limited use due to a lack of efficient data management systems and methods.

Personal data may be acquired from numerous sources through a variety of means. Moreover, the personal data may be stored in various places using various storage means, such as, for example, on a personal computer, on a cell phone, in computer systems or in paper files, etc. The personal data may pertain to a single person or may also pertain to one or more people.

Some organizations offer storage services for information, such as, for example, photos and music. Other organizations provide backup services for all electronic information and/or paper files that a person or organization may have. Advances in technology have generally made memory or storage devices relatively cheap. The relatively low cost of electronic storage media may allow people to amass increasing amounts of files. Unfortunately, the sheer number of files that have been saved may make managing the files so difficult that a person may not be able to benefit to the degree that he or she may like from having saved the files.

### SUMMARY OF THE INVENTION

According to some embodiments of the present invention, media files may be displayed on an electronic calendar based on information associated with the electronic calendar. For example, a media file that is associated with a particular day or month may be displayed on the electronic calendar. Media files may also be displayed on the electronic calendar based on other information associated with the electronic calendar, such as a note about a particular activity to take place during a particular time period or a note about meeting a particular person on a certain day. In these cases, a media file related to the activity or a media file related to the person to be met, respectively, may be displayed. The media files may be selected for display on the electronic calendar by tagging the media files so as to organize the media files into categories. The information associated with the electronic calendar can be compared with the tags to select one or more media files that match or relate to the information associated with the electronic calendar. The selected one or more media files can then be displayed on the electronic calendar.

In particular embodiments of the present invention, an electronic calendar is operated by associating respective ones of a plurality of media files with at least one tag, selecting at least one of the plurality of media files based on information associated with the electronic calendar and the at least one tag, and displaying the at least one of the plurality of media files on the electronic calendar.

In other embodiments of the present invention, associating respective ones of the plurality of media files with at least one tag comprises using at least one media source to generate the plurality of media files. The at least one tag may comprise a time/date tag, a geographic positioning tag, an audio tag, an environmental sensor output tag, a media file content description tag, and/or an identification of a person creating the tag.

In still other embodiments of the present invention, operating the electronic calendar further comprises storing the plurality of media files in a searchable database. Furthermore, selecting at least one of the plurality of media files comprises searching the plurality of media files to determine if a match exists between the tags associated with the plurality of media files and the information associated with the electronic calendar, and selecting at least one of the plurality of media files if a match exists between at least one tag associated with at least one of the plurality of media files and the information associated with the electronic calendar.

In still other embodiments of the present invention, the information associated with the electronic calendar comprises a date.

In still other embodiments of the present invention, the information associated with the electronic calendar further comprises information input by a user for display on the electronic calendar.

In still other embodiments of the present invention, the information associated with the electronic calendar further comprises information input by a user that is associated with at least one day on the electronic calendar, but is not displayed on the electronic calendar.

In still other embodiments of the present invention, the information associated with the electronic calendar further comprises information input by a user as a search request.

In still other embodiments of the present invention, operating the electronic calendar further comprises searching at least one external source to determine if a match exists between an external media file and the information associated with the electronic calendar, and displaying the external media file on the electronic calendar if a match exists between the external media file and the information associated with the electronic calendar.

In still other embodiments of the present invention, at least one external source comprises a Web site on the Internet.

In still other embodiments of the present invention, the plurality of media files comprises a video file, a text file, an audio file, a graphics file, a music file and/or a media file pointer.

Although described primarily above with respect to method aspects of the present invention, it will be understood that the present invention may also be embodied as systems and computer program products.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of exemplary embodiments thereof when read in conjunction with the accompanying drawings, in which:

FIG. 1 is a block diagram that illustrates a system for displaying a media file on an electronic calendar in accordance with some embodiments of the present invention;

FIG. 2 illustrates a data processing system that may be used to implement a media file manager of the communication network of FIG. 1 in accordance with some embodiments of the present invention;

FIG. 3 is a block diagram that illustrates a software/hardware architecture for displaying a media file on an electronic calendar based on information associated with the electronic calendar in accordance with some embodiments of the present invention;

FIGS. 4 and 5 are flowcharts that illustrate operations for displaying a media file on an electronic calendar based on information associated with the electronic calendar in accordance with some embodiments of the present invention; and

FIGS. 5 and 6 are block diagrams that illustrate examples of displaying a media file on an electronic calendar based on information associated with the electronic calendar in accordance with some embodiments of the present invention.

### DETAILED DESCRIPTION OF EMBODIMENTS OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

Some embodiments of the present invention arise from a realization that advances in electronic storage media technology have allowed people to store ever increasing amounts of electronic files, such as digital pictures, music, text, audio, video, and the like. Unfortunately, the sheer magnitude of the number of media files and amount of information that a person may save may make managing the electronic files difficult. As a result, a person may not be able to enjoy the saved media files to the extent that he or she may like because of a lack of applications for managing the media files and/or using the media files in a way that provides value to the person. Some embodiments of the present invention may allow a user to both manage his/her media files and also use them in an electronic calendar application. In particular, media files may be displayed on an electronic calendar based on information associated with the electronic calendar. For example, a media file that is associated with a particular day or month may be displayed on the electronic calendar. Media files may also be displayed on the electronic calendar based on other information associated with the electronic calendar, such as a note about a particular activity to take place during a particular time period or a note about meeting a particular person on a certain day. In these cases, a media file related to the activity or a media file related to the person to be met, respectively, may be displayed. The media files may be selected for display on the electronic calendar by tagging the media files so as to organize the media files into categories. The information associated with the electronic calendar can be compared with the tags to select one or more media files that match or relate to the information associated with the electronic calendar. The selected one or more media files can then be displayed on the electronic calendar. In other embodiments, the association between the one or more media files and the information associated with the electronic calendar may be manually set through user input received via a user interface.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and computer program products in accordance with exemplary embodiments of the invention. These flowchart and/or block diagrams further illustrate exemplary operations for delivering locked content on a communication network, in accordance with some embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

For purposes of illustration, embodiments of the present invention are described herein with respect to displaying media files, such as text, audio, video, music (e.g., Musical Instrument Digital Interface (MIDI) files) and/or graphic files on an electronic calendar. It will be understood that the present invention is not limited to such media file embodiments but may be embodied generally by displaying any type of media file capable of display on an electronic calendar. Moreover, it will be understood that the term “display” means a visual and/or an auditory presentation.

As used herein, the term “file” may include any construct that binds a conglomeration of information, such as instructions, numbers, words, images, audio, and/or video into a coherent unit. Accordingly, a file may be, for example, a document, an image, an email, a database document, an application, an audio recording, a video recording, and/or a Web page.

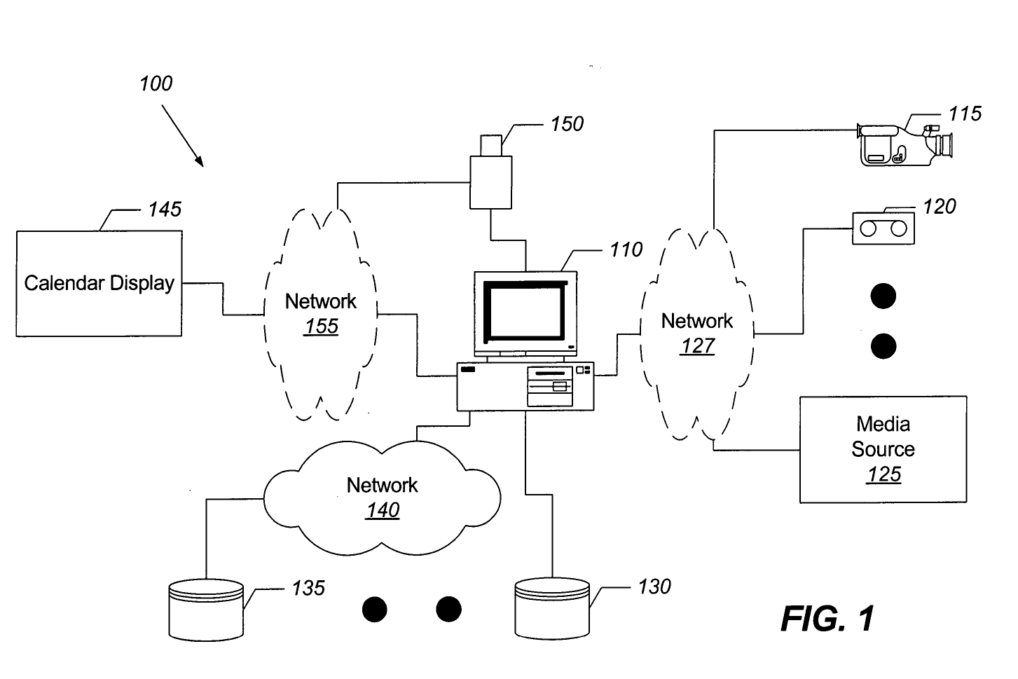

Referring now to FIG. 1, an exemplary network architecture 100 for displaying media file(s) on an electronic calendar, in accordance with some embodiments of the present invention, comprises a media file manager 110 that is connected to media sources 115, 120, and 125. As shown in FIG. 1, the media sources may include, but are not limited to a video recorder/camera 115 and an audio recorder 120. In general, electronic media files may be generated by any source, such as media source 125, in accordance with various embodiments of the present invention. The electronic media files may include, but are not limited to, a video file, a text file, an audio file, a graphics file, a music file and/or a media file pointer. A media file pointer may be a construct that identifies a location of a media file on the same or different storage medium. The various media sources 115, 120, and/or 125 may be connected to the media file manager directly or via a network 127.

The media files generated by the media sources 115, 120, and/or 125 may be tagged and stored in a searchable database 130 connected to the media file manager 110. The searchable database 130 may be directly connected to the media file manager 110 or may be connected to the media file manager 110 via a network. In accordance with various embodiments of the present invention, the media files may be tagged at the media sources 115, 120, and/or 125 and/or at the media file manager 110. The tagging process may involve associating one or more tags or identifiers with a media file so as to facilitate searching for the media file in the searchable database 130. Thus, tagging may create associations between various media files based on common characteristics that these media files may have. Some examples of tags include, but are not limited to, a time/date tag, a geographic positioning tag, an audio tag, an environmental sensor output tag, a media file content description tag, and/or a tag that identifies the person creating the tag. A geographic positioning tag may be obtained through, for example, a global positioning system (GPS). A media file content description tag may be an audio, text, or graphic description of the media file, for example. An environmental sensor output tag may, for example, be any type of environmental data that may be associated with a particular media file. For example, if a media file is a picture of a ski trip, then an environmental sensor output tag may be a temperature recorded at the time the picture was taken. Thus, a media file may have multiple tags associated therewith as it may be categorized in multiple ways. Returning to the skip trip picture example, this media file may include a first tag of “vacation,” a second tag of “snow,” a third tag of “temperature 35 degrees,” and a fifth tag of “Colorado.” In this way, the skip trip picture may be retrieved in searches related to vacations, snow, cold temperatures, and Colorado.

The media file manager 110 may also be connected to external media 135 via a network 140. The external media 135 may represent Web sites on the Internet that may be searched using, for example, search engines accessed through conventional Internet browsers.

The media file manager 110 is connected to a media display device 145 that may be used to display an electronic calendar. According to various embodiments of the present invention, the media display device 145 may be any device that can display an electronic calendar, including, but not limited to, “smart” devices, such as a mobile terminal, a Personal Digital Assistant (PDA), and/or a personal/laptop/notebook computer, and “dumb” devices, such as a display. Moreover, the media file manager 110 and media display device 145 may comprise a single device. The electronic calendar displayed on the media display device 145 may be updated and managed via a calendar application that runs on the media display device 145, media file manager 110, and/or a separate device, such as a mobile terminal 150 that communicates with the media file manager 110. For example, in some embodiments, the mobile terminal 150 and the media file manager 110 may synchronize calendar information, which can then be displayed locally and/or on the media display device 145. The media display device 145 may communicate directly with the media file manager 110 and/or the mobile terminal/PDA 150 or via a network 155.

According to some embodiments of the present invention, the media file manager 110 may use information associated with the electronic calendar on the media display device 145 to search for tagged media files in the database 130. If one or more media files are determined to match the electronic calendar information, then the media file manager 110 may provide the media file(s) to the media display device 145 for display as part of the electronic calendar. Returning to the ski trip picture example discussed above, the digital ski trip picture may be tagged with the date that the picture was taken. On the anniversary of the ski trip date, the calendar manager running on the media display device 145, media file manager 110, and/or mobile terminal 150 provides the date to the media file manager 110 to search for media files in the database 130 that may be tagged with that same date. The digital ski trip picture will be retrieved in the search and provided to the media display device 145 for display on the electronic calendar on the anniversary of the ski trip. In other embodiments, the association between the one or more media files and the information associated with the electronic calendar may be manually set through user input received via a user interface.

The networks 127, 140, and/or 155 may represent a global network, such as the Internet, or other publicly accessible network. The networks 127, 140, and/or 155 may also, however, represent a wide area network, a local area network, an Intranet, or other private network, which may not accessible by the general public. Furthermore, the networks 127, 140, and/or 155 may represent a combination of public and private networks or a virtual private network (VPN).

As used herein, the term “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Wireless phones and or mobile terminals may also be referred to as “pervasive computing” devices.

Although FIG. 1 illustrates an exemplary communication network, it will be understood that the present invention is not limited to such configurations, but is intended to encompass any configuration capable of carrying out the operations described herein.

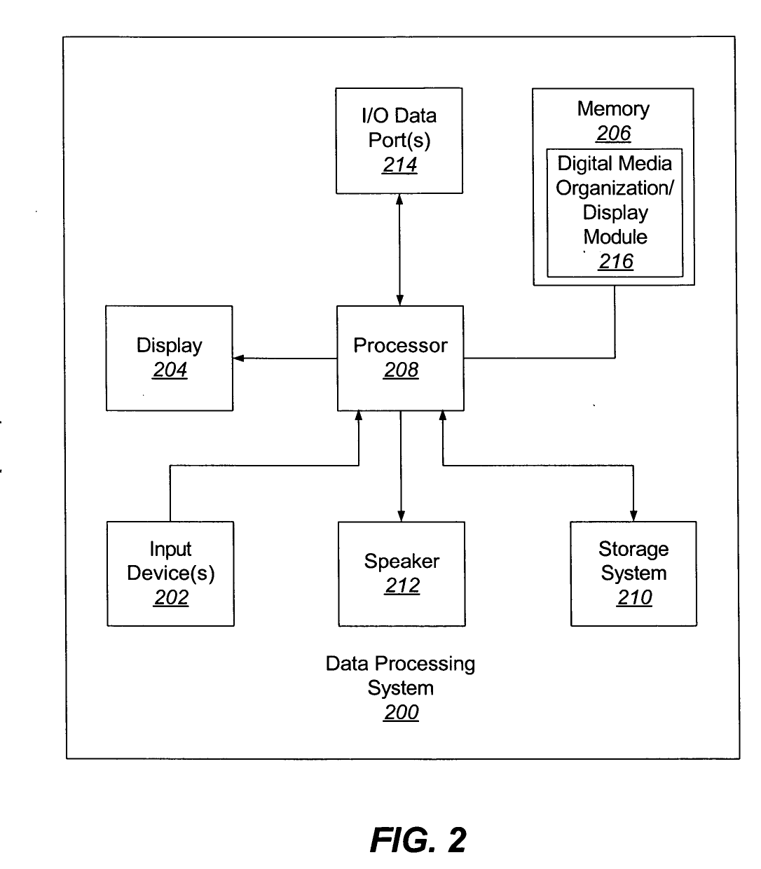

Referring now to FIG. 2, a data processing system 200 that may be used to implement the media file manager 110 of FIG. 1, in accordance with some embodiments of the present invention, comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components, such as those used in many conventional computing devices, and their functionality, with respect to conventional operations, is generally known to those skilled in the art. The memory 206 may be configured with a digital media organization/display module 216 that may be used to search for tagged media files based on information associated with an electronic calendar and to provide the media files to a media display device for display on the electronic calendar in accordance with some embodiments of the present invention.

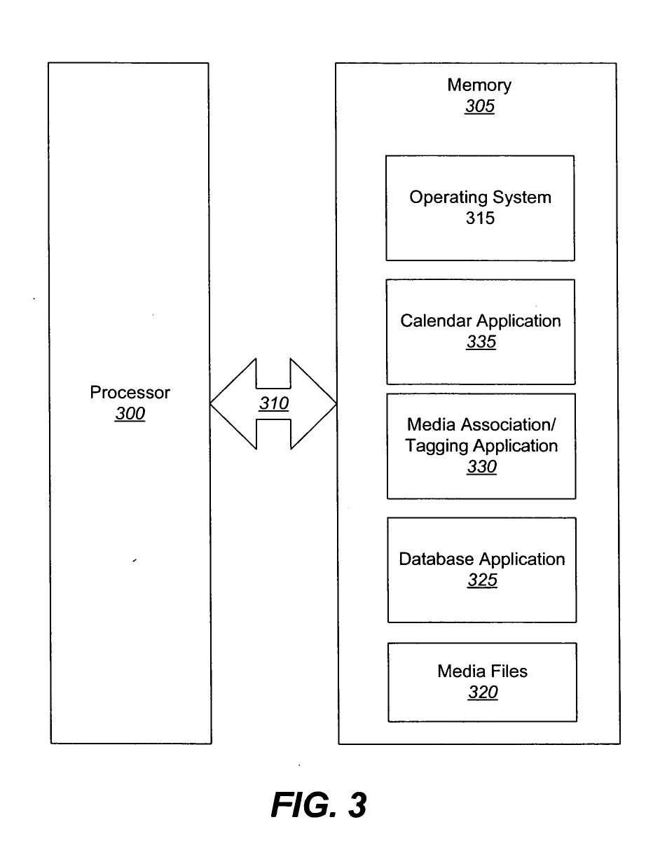

FIG. 3 illustrates a processor 300 and memory 305 that may be used in embodiments of data processing systems, such as the data processing system 200 of FIG. 2, in which one or more media files may be displayed on an electronic calendar in accordance with some embodiments of the present invention. The processor 300 communicates with the memory 305 via an address/data bus 310. The processor 300 may be, for example, a commercially available or custom microprocessor. The memory 305 is representative of the one or more memory devices containing the software and data used for delivering locked content on a communication network in accordance with some embodiments of the present invention. The memory 305 may include, but is not limited to, the following types of devices: cache, ROM, PROM, EPROM, EEPROM, flash, SRAM, and DRAM.

As shown in FIG. 3, the memory 305 may contain up to five or more categories of software and/or data: an operating system 315, media files 320, a database application 325, a media association/tagging application module 330, and a calendar application 335. The operating system 315 generally controls the operation of the data processing system. In particular, the operating system 315 may manage the data processing system's software and/or hardware resources and may coordinate execution of programs by the processor 300. The media files 320 may represent the tagged media files provided by media sources 115, 120, and/or 125 of FIG. 1. The database application 325 may be a software application that organizes the tagged media files 320 in a structured manner that may allow the media file manager to search the media files 320 using various criteria, such as the tags.

The media association/tagging application module 330 may be configured to provide an interface for tagging media files 320 if they are not tagged by the media sources 115, 120, and/or 125 of FIG. 1 or some other system before the media files are communicated to the media file manager 110. The media association/tagging application module 330 may also manage searches of the media files 320 via the database application 325 to determine whether any media files exist that match search terms used that are based on information associated with the electronic calendar.

The calendar application 335 may manage the display of the electronic calendar on the media display device 145. In this regard, the calendar application 335 may obtain the information associated with the electronic calendar, such as the current date (e.g., month and day) and, for example, any information that a user may have associated with particular days, weeks, months, etc. For example, this may include information such as people's names (e.g., a person's birthday may be marked on the calendar), places (e.g., a vacation destination may be marked on the calendar), activity descriptions, and the like. The information may be provided to the media association/tagging application module 330 for use in searching the media files 320. Although the calendar application 335 is shown as residing on the media file manager 110, it will be understood that the calendar application 335 may be implemented on the media file manager 110, the calendar display 145, and/or the mobile terminal 150.

Although FIG. 3 illustrates exemplary hardware/software architectures that may be used in data processing systems, such as the data processing system 200 of FIG. 2, for displaying media files on an electronic calendar, it will be understood that the present invention is not limited to such a configuration but is intended to encompass any configuration capable of carrying out operations described herein. Moreover, the functionality of the media file manager 110, media display device 145, and/or mobile terminal 150 of FIG. 1 and the hardware/software architecture of FIG. 3 may be implemented as a single processor system, a multi-processor system, or even a network of stand-alone computer systems, in accordance with various embodiments of the present invention.

Computer program code for carrying out operations of data processing systems discussed above with respect to FIG. 3 may be written in a high-level programming language, such as Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

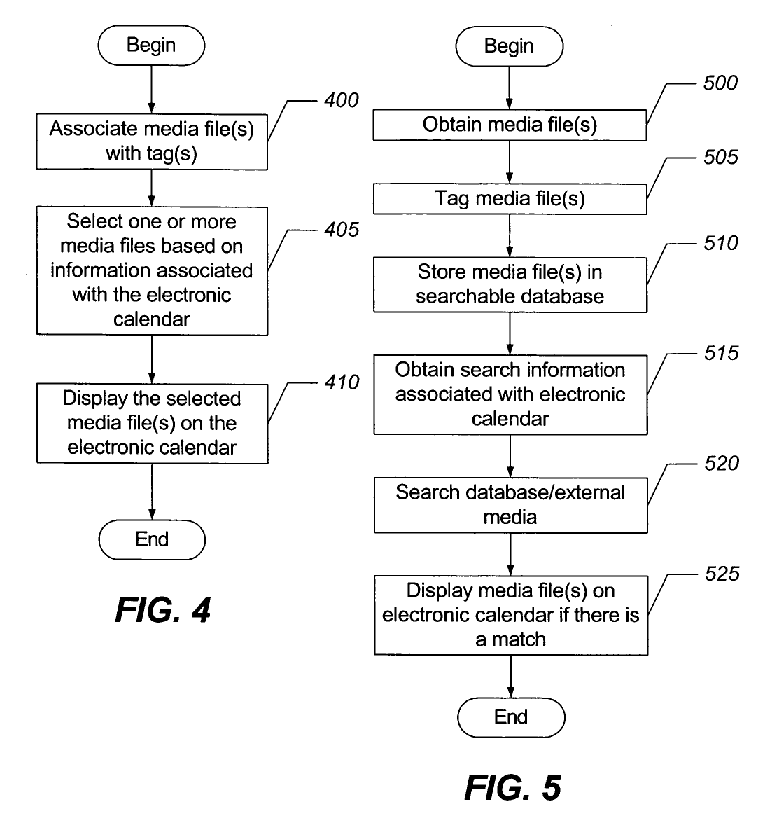

Exemplary operations for displaying a media file on an electronic calendar will now be described with reference to FIG. 4. Operations begin at block 400 where the media sources 115, 120, and/or 125 and/or the media file manager 110 associate the media file(s) with tags. The media file manager 110 selects one or more of the media files for display based on information associated with the electronic calendar at block 405. As discussed above, the media file manager 110 may use the date and/or other information provided by user(s) of the electronic calendar as keywords and/or key phrases to search for media files in the database 130 of FIG. 1 by comparing the keywords and/or key phrases with the tags associated with the media files. The media file manager 110 may then send the selected one or more media files to the media display device 145 of FIG. 1 for display on the electronic calendar. Advantageously, some embodiments of the present invention may allow an electronic calendar to include digital media that is associated in some way with the current date (e.g., day, week, and/or month) and/or with annotations made to the calendar, such as names of people, places, events, and the like.

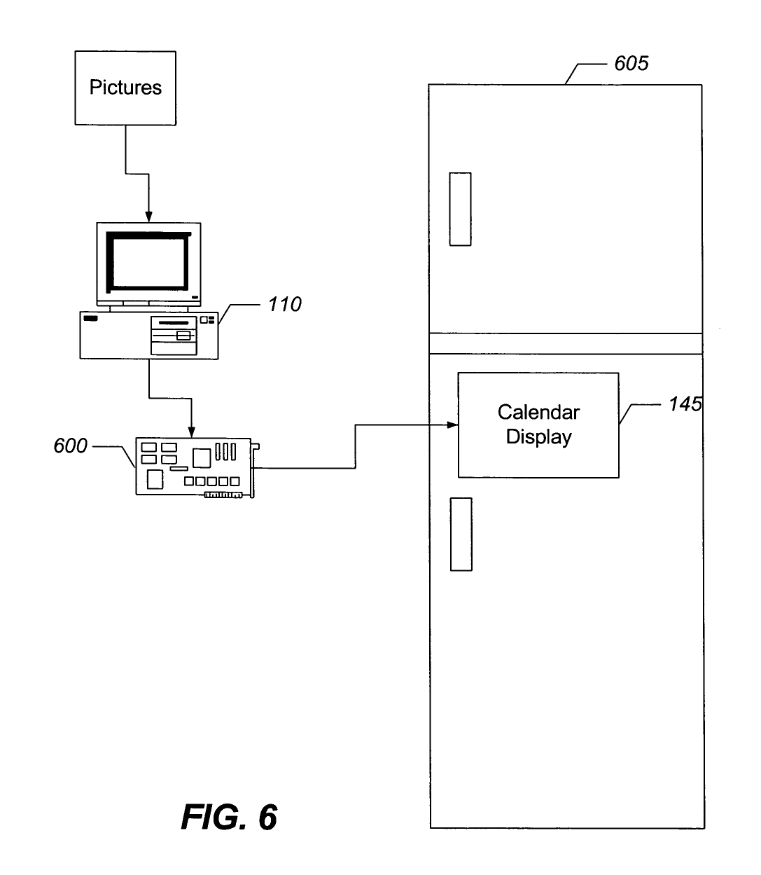

Referring now to FIG. 5, exemplary operations for displaying a media file on an electronic calendar, in accordance with further embodiments of the present invention, begin at block 500 where the media sources 115, 120, and/or 125 obtain media files. As discussed above, the files may be acquired through various techniques including audio and/or video recording, and receiving digital media from other sources. The media sources 115, 120, and/or 125 and/or the media file manager 110 associate the media file(s) with tags at block 505. As discussed above, these tags may include, but are not limited to a time/date tag, a geographic positioning tag, an audio tag, an environmental sensor output tag, a media file content description tag, and/or a tag identifying the person creating the tag. These tags may be used to facilitate searching of the media files in the database 130. At block 510, the media files are stored in the searchable database 130 where they are available for searching by the media file manager 110.

The media file manager 110 may receive search information associated with the electronic calendar at block 515. In accordance with some embodiments of the invention, the search information may default to the current date: The search information may also include, however, information that has been input by a user for display on the electronic calendar. That is, a user may annotate the electronic calendar with various information, such as names of people, places, and/or events. For example, a user may annotate the electronic calendar to indicate that a beach vacation is scheduled for the first week in August with mom and dad. Thus, the media file manager 110 may use the keywords “beach,” “vacation,” “mom,” “dad,” and the date range corresponding to the first week in August as search criteria to search the database 130 for media files that may correspond or be related to any of these criteria.

In other embodiments, a user may annotate the electronic calendar with “hidden” information. This may be information that the user wants to associate with one or more dates on the calendar, but does not want to be displayed on the calendar. The media file manager 110 may use this hidden information for searching the media files to select one or more of the media files for display on the electronic calendar even though the “hidden” information itself is not displayed on the electronic calendar.

In still other embodiments, a user may provide information associated with the electronic calendar directly to the media file manager 110 through, for example, the calendar application 335. Like the information displayed on the electronic calendar and the “hidden” information, the media file manager 110 may use this user provided information to search the media files.

The media file manager 110 performs a search of the media files in the searchable database 130 at block 520. This search may involve comparing the date and/or any additional information associated with the electronic calendar discussed above with the tags associated with the media files. If the media file manager 110 determines that one or more media files correspond or are related to the date and/or the information associated with the electronic calendar, then these media file(s) may be provided to the media display device 145. Returning to the above example in which the electronic calendar is annotated to indicate that a beach vacation is scheduled for the first week in August with mom and dad, the media file manager 110 may select media files corresponding to beach pictures, pictures of mom and/or dad, pictures of other vacations, information on house rentals at the beach, and information on restaurants at the beach based on tags associated with these media files. These selected media files may then be sent to the media display device 145. Note that in some embodiments, the media file manager 110 may search external sources, such as Web sites 135 of FIG. 1 on the Internet, to obtain media files that match or are related to the search information associated with the electronic calendar.

Upon receiving the selected media files, the media display device 145 may display one or more of the selected media files on the electronic calendar at block 525. Thus, the calendar application 335 may choose to display the selected media files corresponding to the beach pictures, pictures of mom and/or dad, and house rental/restaurant information several weeks prior to the first week in August as a reminder that the beach vacation is coming up soon.

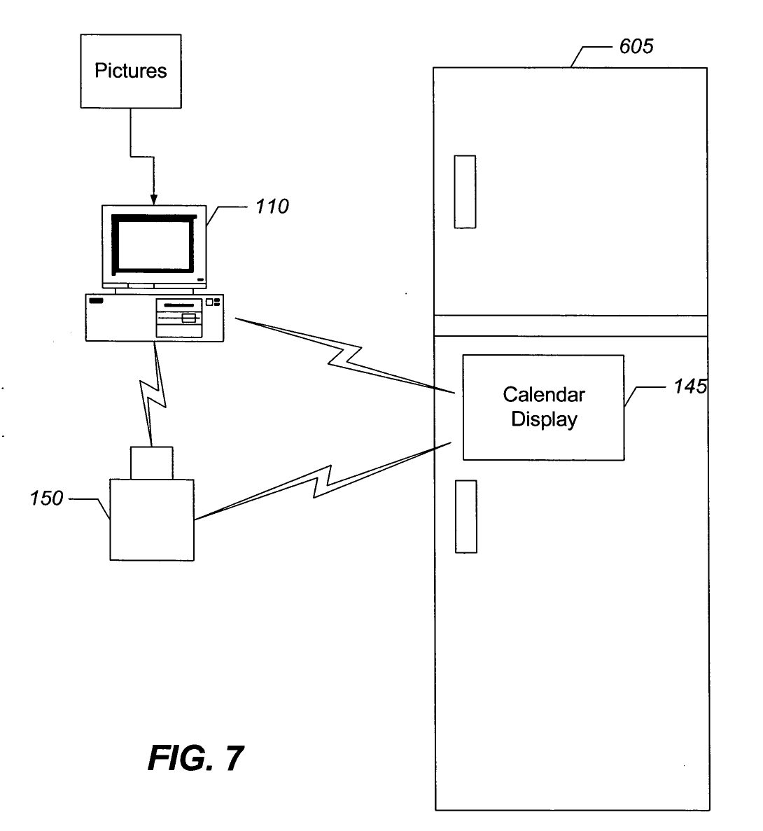

Further embodiments of the present invention may be illustrated by way of example with reference to FIGS. 6 and 7. Referring now to FIG. 6, media files, such as digital pictures are obtained using, for example, a digital camera or scanning existing pictures. These digital pictures are provided to the media file manager 110 via a Universal Serial Bus (USB) connection and tagged to identify who the people are in each of the pictures. The media file manager 110 is programmed with birthday information for each of the people in the pictures from the media display device 145. Accordingly, the media file manager 110 associates each picture with the birth date for the person in the picture and stores this information along with the digital pictures in a flash memory 600. The flash memory 600 is installed in the media display device 145, which is built into or attached to a refrigerator 605. As a result, for each person in the digital pictures, his/her picture is displayed on the electronic calendar on the media display device 145 on his/her birthday.

Referring now to FIG. 7, this example is similar to the example illustrated in FIG. 6 with the exception that the digital pictures and birthday information may be communicated to the media display device 145 by the media file manager 110 and/or a mobile terminal 150 using a wireless communication interface. The mobile terminal 150 and the media file manager 110 may synchronize calendar information so that either device may communicate media files to the media display device 145 for display.

The flowchart of FIGS. 4 and 5 illustrate the architecture, functionality, and operations of some embodiments of methods, systems, and computer program products for displaying media files on an electronic calendar. In this regard, each block represents a module, segment, or portion of code, which comprises one or more executable instructions for implementing the specified logical function(s). It should also be noted that in other implementations, the function(s) noted in the blocks may occur out of the order noted in FIGS. 4 and 6. For example, two blocks shown in succession may, in fact, be executed substantially concurrently or the blocks may sometimes be executed in the reverse order, depending on the functionality involved.

Many variations and modifications can be made to the preferred embodiments without substantially departing from the principles of the present invention. All such variations and modifications are intended to be included herein within the scope of the present invention, as set forth in the following claims.

That which is claimed:

1. A method of operating an electronic calendar, comprising:
associating respective ones of a plurality of media files with at least one tag;
selecting at least one of the plurality of media files based on information associated with the electronic calendar and the at least one tag; and
displaying the at least one of the plurality of media files that was selected on the electronic calendar.

2. The method of claim 1, wherein associating respective ones of the plurality of media files with at least one tag comprises:
using at least one media source to generate the plurality of media files; and
wherein the at least one tag comprises:
a time/date tag, a geographic positioning tag, an audio tag, an environmental sensor output tag, a media file content description tag, and/or an identification of a person creating the tag.

3. The method of claim 1, further comprising:
storing the plurality of media files in a searchable database; and
wherein selecting the at least one of the plurality of media files comprises:
searching the plurality of media files to determine if a match exists between the tags associated with the plurality of media files and the information associated with the electronic calendar; and
selecting the at least one of the plurality of media files if a match exists between at least one tag associated with the at least one of the plurality of media files and the information associated with the electronic calendar.

4. The method of claim 3, wherein the information associated with the electronic calendar comprises a date.

5. The method of claim 3, wherein the information associated with the electronic calendar further comprises information input by a user for display on the electronic calendar.

6. The method of claim 3, wherein the information associated with the electronic calendar further comprises information input by a user that is associated with at least one day on the electronic calendar, but is not displayed on the electronic calendar.

7. The method of claim 3, wherein the information associated with the electronic calendar further comprises information input by a user as a search request.

8. The method of claim 3, further comprising:
searching at least one external source to determine if a match exists between an external media file and the information associated with the electronic calendar; and
displaying the external media file on the electronic calendar if a match exists between the external media file and the information associated with the electronic calendar.

9. The method of claim 8, wherein the at least one external source comprises a Web site on the Internet.

10. The method of claim 1, wherein the plurality of media files comprises a video file, a text file, an audio file, a graphics file, a music file and/or a media file pointer.

11. An electronic calendar system, comprising:
a media file manager that is configured to associate respective ones of a plurality of media files with at least one tag and to select at least one of the plurality of media files based on information associated with an electronic calendar and the at least one tag; and
a media display device that is configured to display the at least one of the plurality of media files that was selected on the electronic calendar.

12. The system of claim 11, further comprising:
at least one media source that is connected to the media file manager and is configured to generate the plurality of media files; and
wherein the at least one tag comprises:
a time/date tag, a geographic positioning tag, an audio tag, an environmental sensor output tag, a media file content description tag, and/or an identification of a person creating the tag.

13. The system of claim 11, further comprising:
a searchable database that is connected to the media file manager and comprises the plurality of media files; and
wherein the media file manager is further configured to search the plurality of media files in the searchable database to determine if a match exists between the tags associated with the plurality of media files and the information associated with the electronic calendar, and to select the at least one of the plurality of media files if a match exists between at least one tag associated with the at least one of the plurality of media files and the information associated with the electronic calendar.

14. The system of claim 13, wherein the information associated with the electronic calendar comprises a date.

15. The system of claim 13, further comprising a calendar application configured to manage the electronic calendar; and
wherein the information associated with the electronic calendar further comprises information input by a user to the calendar application for display on the electronic calendar.

16. The system of claim 13, further comprising a calendar application configured to manage the electronic calendar; and
wherein the information associated with the electronic calendar further comprises information input by a user to the calendar application that is associated with at least one day on the electronic calendar, but is not displayed on the electronic calendar.

17. The system of claim 13, further comprising a calendar application configured to manage the electronic calendar; and
wherein the information associated with the electronic calendar further comprises information input by a user to the calendar application as a search request.

18. The system of claim 13, wherein the media file manager is further configured to search at least one external source to determine if a match exists between an external media file and the information associated with the electronic calendar; and
wherein the media display device is further configured to display the external media file on the electronic calendar if a match exists between the external media file and the information associated with the electronic calendar.

19. A computer program product for operating an electronic calendar, comprising:
a computer readable storage medium having computer readable program code embodied therein, the computer readable program code comprising:
computer readable program code configured to associate respective ones of a plurality of media files with at least one tag;
computer readable program code configured to select at least one of the plurality of media files based on information associated with the electronic calendar; and
computer readable program code configured to display the at least one of the plurality of media files on the electronic calendar.

20. The computer program product of claim 19, further comprising:
computer readable program code configured to store the plurality of media files in a searchable database; and
wherein the computer readable program code configured to select the at least one of the plurality of media files comprises:
computer readable program code configured to search the plurality of media files to determine if a match exists between the tags associated with the plurality of media files and the information associated with the electronic calendar; and
computer readable program code configured to select the at least one of the plurality of media files if a match exists between at least one tag associated with the at least one of the plurality of media files and the information associated with the electronic calendar.
